(19) United States
(12) Patent Application Publication
(10) Pub. No.: US 2025/0272665 A1
(43) Pub. Date: Aug. 28, 2025

(54) SYSTEMS AND METHODS FOR CONSENT MANAGEMENT BY ISSUERS ON BEHALF OF CARDHOLDERS

(71) Applicant: Mastercard International Incorporated, Purchase, NY (US)

(72) Inventors: Adam Kenneth Hosp, Lake St. Louis, MO (US); Oran Cummins, Dublin (IE); Michael Hoole, Epsom (GB); Ahmed Hosny, Dublin (IE); Ishfaq Lone, Dublin (IE); Marco Vicente, Dublin (IE); Piyushkumar Kanubhai Hirpara, Dublin (IE); Kosta Krauth, New York, NY (US)

(73) Assignee: Mastercard International Incorporated, Purchase, NY (US)

(21) Appl. No.: 19/208,041

(22) Filed: May 14, 2025

Related U.S. Application Data
(63) Continuation of application No. 17/490,591, filed on Sep. 30, 2021.
(60) Provisional application No. 63/086,082, filed on Oct. 1, 2020.
(60) Provisional application No. 63/232,880, filed on Aug. 13, 2021.
(60) Provisional application No. 63/232,895, filed on Aug. 13, 2021.

(51) Int. Cl. G06Q 20/02; G06Q 20/32; G06Q 20/34; G06Q 20/38; G06Q 20/40; G06Q 20/42; G06Q 40/02; H04L 9/40

(52) U.S. Cl. CPC G06Q 20/02; G06Q 20/3255; G06Q 20/34; G06Q 20/382; G06Q 20/3821; G06Q 20/385; G06Q 20/401; G06Q 20/4014; G06Q 20/40975; G06Q 20/42; G06Q 40/02; H04L 63/083

(57) ABSTRACT

A computer system includes a database, a communication interface, and a processor. The processor is programmed to receive a request message from an issuer computing device. The consent message includes a client ID and encrypted transaction card details for a transaction card account. The processor is also programmed to decrypt transaction card details. The processor is also programmed to match the client ID to the transaction card details using a BIN mapping table stored in the database. Based on the mapping, the processor generates an issuer access token. The issuer access token is associated with the transaction card account. The processor stores the issuer access token in the database and transmits the token to the issuer computing device.

### CROSS-REFERENCE TO RELATED APPLICATIONS

### Priority Applications

This application is a continuation application of identically titled U.S. patent application Ser. No. 17/490,591 filed Sep. 30, 2021, which claims priority from U.S. Provisional Patent Application No. 63/086,082, filed Oct. 1, 2020, and entitled SYSTEMS AND METHODS FOR SECURELY OPENING APIS WITH CARDHOLDER AUTHENTICATION AND CONSENT; U.S. Provisional Patent Application No. 63/232,880, filed Aug. 13, 2021, and entitled SYSTEMS AND METHODS FOR MULTI ACCESS CHANNELS FOR AUTHENTICATION AND CONSENTS; and U.S. Provisional Patent Application No. 63/232,895, filed Aug. 13, 2021, and entitled SYSTEMS AND METHODS FOR CONSENT MANAGEMENT BY ISSUERS ON BEHALF OF CARDHOLDERS. The entire disclosure of each of the aforementioned applications is hereby incorporated by reference herein.

### FIELD OF THE DISCLOSURE

The field of the disclosure relates to cardholder authentication and consent management systems, and more particularly, to managing digital access tokens based on cardholder authentication and consent, where the digital access tokens are linked to application programming interface (API) calls to retrieve cardholder financial data.

### BACKGROUND

The open banking concept in financial services is based, in part, on the use of open APIs allowing financial technology companies (Fintechs) and third party providers (TPPs) to build applications and services around financial institutions, increased financial transparency options for account holders, and the use of open source technology to implement these services and results. To provide such services, the Fintechs/TPPs require access to a cardholder's account data. However, issuers need to maintain some control over a Fintech's access to a consumer's account data, for example, based on regulatory requirements and/or for the convenience of the consumer.

Consumer's may grant a Fintech access to the consumer's account data, for example, via a digital access token. The issuer, however, may be left out of the arrangement, and cannot therefore facilitate management of the consumer's consent with the Fintech. Further, some consumer's may forget which Fintechs have access to their account data and may not be able to revoke such access. Because the issuer is typically not part of the process of granting permission to the Fintech to access the account data, the issuer may be unable to revoke access on behalf of the consumer.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computing system is provided. The computing system includes a database, a communication interface, and a processor. The processor is coupled in communication to the database and the communication interface. The processor is programmed to receive, via the communication interface, a request message from an issuer computing device. The request message includes a client ID and encrypted transaction card details for a transaction card account associated with an issuer. The processor is also programmed to decrypt the encrypted transaction card details and match the client ID to the transaction card details using a BIN mapping table stored in the database. In response to the transaction card details being matched with the client ID, the processor generates an issuer access token by a token service system. The issuer access token is associated with the transaction card account. The processor is further programmed to store the issuer access token in the database and transmit, via the communication interface, the issuer access token to the issuer computing device.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party network system, in accordance with one embodiment of the present disclosure;

FIG. 2 is an example configuration of a cardholder computing device shown in FIG. 1 that may be operated by a cardholder shown in FIG. 1;

FIG. 3 is an example configuration of a computing system for use in the network system shown in FIG. 1;

FIG. 4 is an example configuration of a server system for use in the network system shown in FIG. 1;

FIG. 5 depicts a flowchart illustrating various example actions performed by components of the network system shown in FIG. 1 to request the provisioning of an issuer access token;

FIG. 6 depicts a flowchart illustrating various example actions performed by components of the network system shown in FIG. 1 to enable an issuer to retrieve financial data access consent and/or permissions granted by a cardholder to a third party; and

FIG. 7 depicts a flowchart illustrating various example actions performed by components of the network system shown in FIG. 1 to enable an issuer to add a “watch” to one or more of its customer transaction card accounts.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

As used herein, the terms “payment card,” “transaction card,” and “financial transaction card,” may include any suitable transaction card, such as a credit card, a debit card, a charge card, a membership card, a promotional card, an identification card, a prepaid card, a gift card, and/or any other card-type device that may hold payment account information. Each type of transaction card can be used as a method of payment for performing a transaction.

### Exemplary Consent Management System

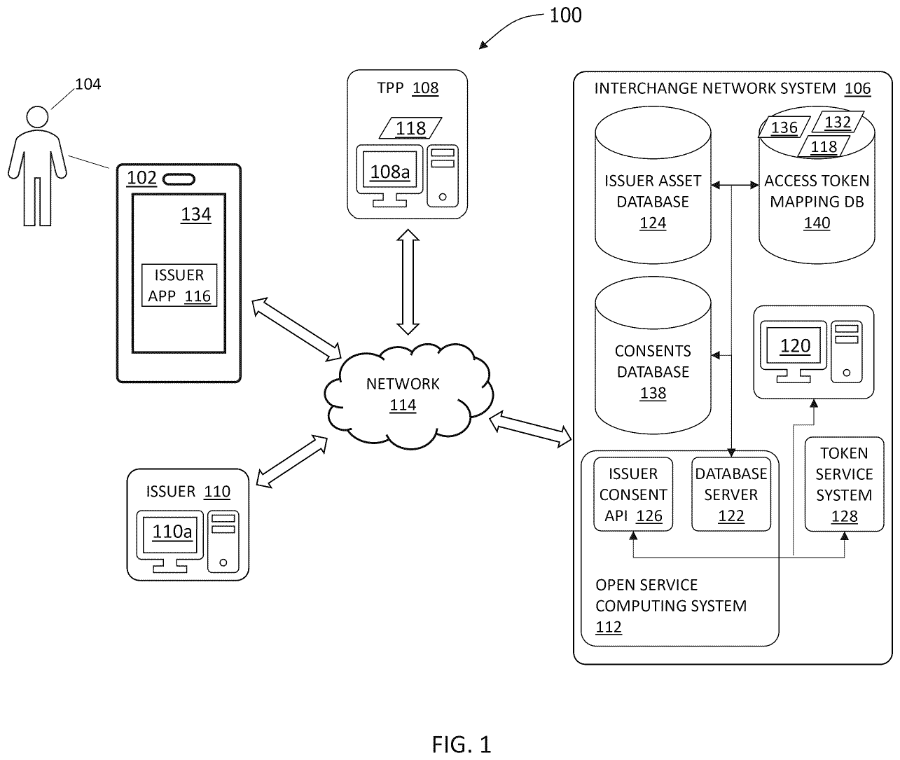

FIG. 1 is a block diagram of an example multi-party network system 100, including a cardholder computing device 102 (e.g., a mobile computing device) belonging to a cardholder (or consumer) 104, in accordance with one embodiment of the present disclosure. In the exemplary embodiment, the network system 100 provides interchange network services offered by one or more payment networks, such as interchange network system 106. In addition, the network system 100 enables financial data transactions and services related to transaction cards in which cardholders 104, third party providers (TPPs) 108 (also may be referred to herein as Fintechs), and card issuers (e.g., issuer 110) do not need to have a one-to-one relationship. Although parts of the network system 100 are presented in one arrangement, other embodiments may include the same or different parts arranged otherwise, depending, for example, on authentication and consent processes, communication between computing devices, etc.

It is noted that Fintechs and TPPs, such as TPP 108, provide cardholders, such as cardholder 104, access to new products and services related to a cardholder's financial accounts. TPPs/Fintechs include, for example, account information service providers (AISPs), payment initiation service providers (PISPs), etc. Examples include PayPal®, Square®, Stripe®, etc. In order for the TPPs/Fintechs to provide account services to a cardholder, the TPPs/Fintechs require access to the cardholder's financial information.

In the example embodiment, the network system 100 generally includes the cardholder computing device 102, the interchange network system 106 including an open service computing system 112, the TPP 108 (via a third party provider computing device 108a), and the issuer 110 (via an issuer computing device 110a) coupled in communication via a communications network 114. The network 114 includes, for example and without limitation, one or more of a local area network (LAN), a wide area network (WAN) (e.g., the Internet, etc.), a mobile network, a virtual network, and/or any other suitable public and/or private network capable of facilitating communication among the cardholder computing device 102, the open service computing system 112, the interchange network system 106, the issuer 110, and/or the TPP 108. In some embodiments, the network 114 includes more than one type of network, such as a private transaction network provided by the interchange network system 106 to the TPP 108, and the issuer 110, and, separately, the public Internet, which may facilitate communication between the cardholder computing device 102, the TPP 108, the issuer 110, the open service computing system 112, and/or the interchange network system 106, etc.

Embodiments described herein relate to transaction card systems, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated.

With continued reference to FIG. 1, in the exemplary embodiment, the cardholder computing device 102 (e.g., a smartphone or other computing device used by the cardholder 104) includes a user interface 134 that facilitates user interaction with the respective cardholder computing device 102. For example, and without limitation, the user interface 134 enables the cardholder 104 to input data to the cardholder computing device 102, and the cardholder computing device 102 to present (e.g., output) information to the cardholder 104 (e.g., on a display of the cardholder computing device 102). The user interface 134 includes, for example, one or more Bank Applications 116 (broadly, a Bank App), which is installed on the cardholder computing device 102. In the exemplary embodiment, the Bank App 116 provides communication to the issuer 110 (via the issuer computing device 110a) and various financial services to the cardholder 104 via the issuer 110. It is contemplated that fewer or more Bank Apps may be installed on the cardholder computing device 102 and displayed by the user interface 134, where each Bank App is associated with at least one financial service provider (e.g., the issuer 110).

In the exemplary embodiment, the cardholder computing device 102 communicates with one or more of the issuer 110 (via the issuer computing device 110a) and the TPP 108 (via the TPP computing device 108a), for example, via the network 114. In addition, the cardholder computing device 102 communicates with the open service computing system 112, for example, via the network 114, to exchange and/or synchronize authentication, consent, and/or financial account data. The open service computing system 112 accesses the network 114 to communicate with the cardholder computing device 102, the issuer 110, and the TPP 108 to facilitate the establishment of one or more digital access tokens 118, and the exchange of cardholder financial account data with the issuer 110 and the TPP 108.

The cardholder computing device 102 can be any computing device capable of interconnecting to the network 114, such as the Internet, including a desktop computer, laptop, mobile web-based device, smartphone, PDA, or other mobile web-based connectable equipment. The cardholder computing device 102 is interconnected to the Internet through one or more interfaces including a network, such as a local area network (LAN) or a wide area network (WAN), dial-in-connections, cable modems, wireless modems, and special high-speed ISDN lines. In addition, in the example embodiment, the cardholder computing device 102 is configured to communicate with other cardholder computing devices (not shown) and/or merchant point-of-sale (POS) systems (not shown) using various forms of communication including, for example, radio frequency communication, near field communication (NFC), network-based communication, and the like.

The network system 100 includes, for example, and without limitation, one or more computers, servers, networks of multiple computing devices, virtual computing devices, and the like. In addition, in the exemplary embodiment, the network system 100 also includes one or more payment network server systems 120 (also referred to as a payment system), which is part of the interchange network system 106 and is coupled in communication to the network 114. The payment system 120 is a computing system including, for example, a web application server, an application programming interface (API) server, and a memory device, enabling the interchange network system 106 to be in communication with the open service computing system 112 using, for example, and without limitation, an internal network and/or the Internet. The payment system 120 is interconnected to the Internet through one or more interfaces including a network, such as a local area network (LAN) or a wide area network (WAN), dial-in-connections, cable modems, and special high-speed ISDN lines. The payment system 120 can be any computing device capable of interconnecting to the Internet. In certain embodiments of the present invention, the open service computing system 112 is integrated with or is otherwise a part of the payment network server system 120.

The open service computing system 112 includes, for example, a database server 122, which is connected to one or more databases, such as an issuer assets database 124, a consents database 138, and a token mapping database 140. In one embodiment, the databases 124, 138, and 140 are stored on the open service computing system 112. In an alternative embodiment, the databases 124, 138, and 140 may be stored remotely from the open service computing system 112 and/or may be non-centralized. The databases 124, 138, and 140 are configured to receive and store, at least, data mapping respective cardholder accounts to respective issuers 110, one or more digital access tokens 118, account data and/or information associating respective access tokens 118 to respective cardholder accounts, cardholder consent data associated with the respective access tokens 118, and/or other data or information associated with the cardholder 104, issuers 110, and/or digital access tokens 118 (e.g., token status, generation date, expiry date, authorized TPP, etc.).

Furthermore, the open service computing system 112 includes an issuer consent management application programming interface (API) 126. In the exemplary embodiment, the issuer consent management API 126 facilitates the management (creation, suspension, deletion, etc.) of the digital access token 118 for the TPP 108. The issuer consent management API 126 stores the digital access tokens 118, cardholder consent, transaction card details, token expiration, other associated data or information, etc. in one or more of the databases 124, 138, and 140.

In the exemplary embodiment, the cardholder computing device 102 is used to run the Bank App 116, which establishes a connection with an associated issuer 110, for example, via the network 114. The issuer 110 may provide third party consent management services to the cardholder 104 via the Bank App 116. To provide the services, the issuer 110 may require access to the cardholder consent associated with the access token 118, access token data, etc. that is stored or held by the interchange network system 106. In certain embodiments, the cardholder 104 may have given a third party, such as the TPP 108, consent to access certain financial data of the cardholder. The issuer 110 may facilitate management of the cardholder consent for the cardholder 104, for example, via the open service computing system 112.

In one suitable embodiment, the cardholder 104 may have an existing relationship with the TPP 108 and may have linked one or more transaction card accounts with the TPP service, for example, via a TPP App (not shown). In such instances, the TPP 108 may have a digital access token 118 granting the TPP 108 access to certain financial data of the cardholder 104. For example, in one example embodiment, to gain access to the cardholder's financial account data, the TPP 108 requests permission from the cardholder 104 to register the transaction card account and receive the financial account data. The TPP 108 communicates with the open service computing system 112 and transmits a secure request message to authenticate the cardholder and receive access to cardholder financial account data. The permissions the TPP 108 may be requesting can include, for example, a request for access to one or more of a cardholder's transaction alerts, transaction history, virtual card numbers, card controls, etc. The interchange network system 106 includes a token service system 128, which is configured to generate or assign one or more access tokens, such as access token 118, to respective cardholder transaction card accounts. The token service system 128 generates or assigns a digital access token (e.g., the digital access token 118) to be associated with the cardholder's transaction card and creates an association mapping between the digital access token and the transaction card. The token service system 128 stores the token-to-card mapping data (e.g., in a data mapping table 136) in a database, such as the token mapping database 140. The token service system 128 transmits the digital access token to the TPP 108, for example, via the open service computing system 112, such that the digital access token can be used in subsequent data service requests initiated by the TPP 108.

The cardholder 104 may wish to revoke his or her consent, and hence the digital access token 118, from the TPP 108. The issuer 110 may facilitate revocation of the digital access token 118 for the cardholder 104 via the issuer consent management API 126. For example, the cardholder 104 may contact the issuer 110, via the issuer computing device 110a, to initiate revocation of the digital access token 118. The issuer 110 may authenticate the cardholder 104, for example, via a one-time password (OTP) authentication process, a biometric sample, password, PIN, or any other suitable authentication identifier (ID) or authentication process. etc. Upon authenticating the cardholder 104 and his or her revocation request, the issuer 110 may retrieve the cardholder consents given the TPP 108 and revoke one or more of the consents as described further herein. It is noted that in addition to revoking cardholder consent and/or the digital access token 118, the issuer 110 may also provide consent on behalf of the cardholder 104 for generation of a digital access token 118 to be provided to a TPP 108.

The embodiments illustrated and described herein, as well as embodiments not specifically described herein but within the scope of aspects of the invention, constitute exemplary means for revoking or generating a digital access token, such as the digital access token 118, that grants access to a cardholder's financial account data. For example, the cardholder computing device 102, the issuer computing device 110a, the open service computing system 112, the token service system 128, or any other similar computer device(s), programmed with computer-executable instructions to execute processes and techniques with a processor as described herein, constitute exemplary means for enabling a cardholder, such as the cardholder 104, to revoke access to or provide his or her transaction card information to a third party provider (e.g., the TPP 108) and revoke or provide consent to the third party provider for retrieving certain financial account data of the cardholder 104 from a data store (e.g., the interchange network system 106).

### Exemplary Computer Systems

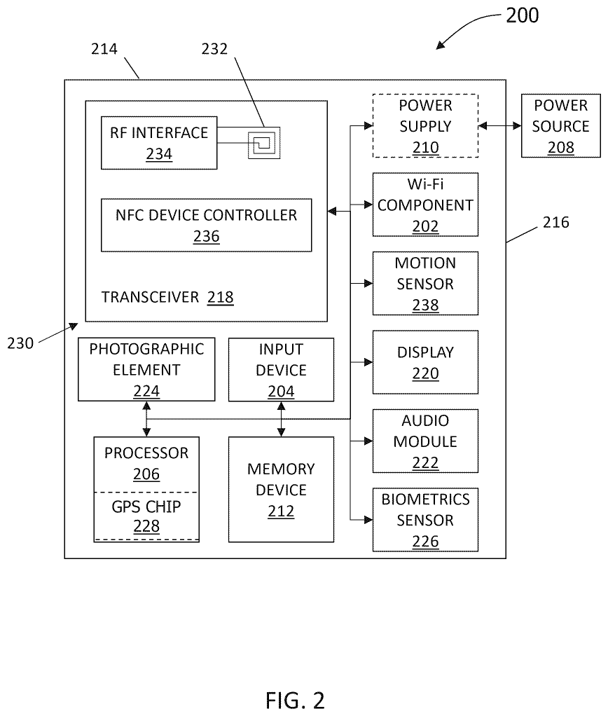

FIG. 2 is an example configuration of a user computing system 200, such as the cardholder computing device 102 (shown in FIG. 1), that may be operated by a user, such as the cardholder 104 (shown in FIG. 1). In the exemplary embodiment, the computing system 200 is a computing device configured to connect to one or more of the open service computing system 112, the issuer 110, the TPP 108, and any other computing devices, such as other customer computing devices (not shown).

In the exemplary embodiment, the computing system 200 generally includes a processor 206, a memory device 212, a transceiver 218 (or a wireless communication device), a photographic element 224, and a biometrics sensor 226. In addition, the computing system 200 includes an integrated Wi-Fi component 202 (e.g., implementing the Institute of Electrical and Electronics/IEEE 802.11 family of standards), an input device 204, a display 220, and an audio module 222. Moreover, the computing system 200 includes an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 includes one or more processing units (e.g., in a multi-core configuration) specially programmed for executing computer readable instructions. The computer readable instructions may be executed within a variety of different operating systems (OS) on the cardholder computing device 102, such as UNIX, LINUX, Microsoft Windows®, etc. More specifically, the computer readable instructions may cause various data manipulations on data stored in the memory device 212 (e.g., create, read, update, and delete procedures). It should also be appreciated that upon initiation of a computer-based method, various computer readable instructions may be executed during initialization. Some operations may be required to perform one or more processes described herein, while other operations may be more general and/or specific to a programming language (e.g., C, C#, C++, Java, or other suitable programming languages, etc.). The memory device 212 is any device allowing information such as the computer readable instructions and/or written works to be stored and retrieved. The memory device 212 includes one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for conducting cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for the computing system 200. Therefore, the network system 100 provides a mechanism for automatically updating the software on the computing system 200. For example, an updating mechanism may be used to automatically update any number of components and their drivers, both network and non-network components, including system level (OS) software components. In some embodiments, the computing system 200 components are dynamically loadable and unloadable; thus, they may be replaced in operation without having to reboot the OS.

A location of the computing system 200 can be obtained, for example, via a location service (e.g., global positioning system (GPS) service) in the computing system 200, “ping” data that includes geotemporal data, from cell location register information held by a telecommunications provider to which the computing system 200 is connected, and the like. For example, in one suitable embodiment, an optional GPS chip 228 can be part of or separate from the processor 206 to enable the location of the computing system 200 to be determined.

Stored in the memory device 212 are, for example, computer readable instructions for providing a user interface, such as the user interface 134, to the user via the display 220 and, optionally, receiving and processing input from the input device 204. A user interface may include, among other possibilities, a web browser and the Bank App 116 (shown in FIG. 1). Web browsers enable users, such as the cardholder 104, to display and interact with media and other information typically embedded on a web page or a website. The Bank App 116 allows the user to interact with computers of the issuer 110 to request revocation of the digital access token 118 and/or to provide transaction card details, cardholder consent, and cardholder authentication information thereto.

The photographic element 224 may include a camera or other optical sensor and lens combination capable of generating a video signal and capturing an image. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

The biometrics sensor 226 is a biometric input device coupled in communication with at least the processor 206 and the memory device 212. The biometrics sensor 226 enables the user to enter a biometric sample. For example, the biometrics sensor 226 is a hardware component and includes, for example, an integral fingerprint or palm reader/scanner, retinal or iris reader/scanner, camera, and/or voice reader/recorder. The user inputs one or more biometrics and stores them as a biometric profile in the memory device 212. The biometrics of the user, such as the cardholder 104, includes one or more scans or digital representations of physical features of the user that are to be validated/authenticated during generation of the digital access token 118. The biometrics or physical features can include, for example, and without limitation, voice, fingerprint, iris, vein pattern, face, or the like. Feature data from a biometric scan or digital representation may be extracted to select features of interest. The biometric profile may be further stored, for example, by the issuer 110 and/or the interchange network system 106 in the database 124.

In some embodiments, the motion sensor 238 may include one or more sensor elements that facilitate detecting a person's presence. For example, if the computing system 200 is operating as the cardholder computing device 102, the motion sensor 238 detects when the cardholder 104 moves or raises the cardholder computing device 102. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the person's presence may be detected by detecting motion using the photographic element 224. The motion sensor 238 may include, for example, and without limitation, sensor elements such as a passive infrared sensor, an ambient light sensor, and the like.

In the example embodiment, the display 220 can include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect a person's presence by detecting that the person has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 114 (shown in FIG. 1) and/or other computing devices (e.g., other cardholder computing devices, the open service computing system 112, the issuer computing device 110a, the TPP computing device 108a, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the cardholder computing device 102. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 is fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 is fabricated from any material that enables the computing system 200 to function as described herein, such as metals, etc.

In one embodiment, the transceiver 218 includes an antenna 232. The antenna 232 includes a looped wire configured to transmit radio signals when current flows through the looped wire. The antenna 232 is any size, shape, and configuration that is suitable for transmitting signals as described herein. For example, the antenna 232 is a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 is configured to vibrate at a frequency of about 13.56 MHz, which is suitable for use in a near field communication (NFC) system.

In the example embodiment, the antenna 232 transmits radio signals to and receives radio signals from other NFC-enabled computing devices, such as, another cardholder computing device, merchant point-of-sale (POS) systems (not shown), and/or any other components used in NFC systems. In NFC systems, at least one NFC component generates a magnetic field to inductively transfer currents and, thereby, exchange signals and information with other NFC components positioned within the magnetic field. In the exemplary embodiment, the antenna 232 functions as an NFC component to send and receive signals. The antenna 232 is configured to transmit radio signals to NFC components positioned within the magnetic field of the antenna 232, such as when the cardholder computing device 102 is located within a predetermined distance of another cardholder computing device and/or a merchant point-of-sale system (not shown). Therefore, the magnetic field generated by the antenna 232 defines the active range of the computing system 200. Additionally, the antenna 232 receives radio signals from NFC components when the antenna 232 is positioned within the magnetic field of the NFC components.

The transceiver 218 also includes a radio frequency (RF) interface 234 and an NFC device controller 236. The RF interface 234 and the NFC device controller 236 are powered by the power source 208, and in some embodiments, the internal power supply 210 and/or the display 220. In addition, the processor 206 and the memory device 212 are powered in the same manner. The RF interface 234 is configured to receive and transmit RF signals through the antenna 232. The NFC device controller 236 is configured to process the received RF signals and to generate signals to be transmitted by the RF interface 234. The memory device 212 is configured to store data associated with transmitting and receiving the RF signals. The NFC device controller 236 is coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

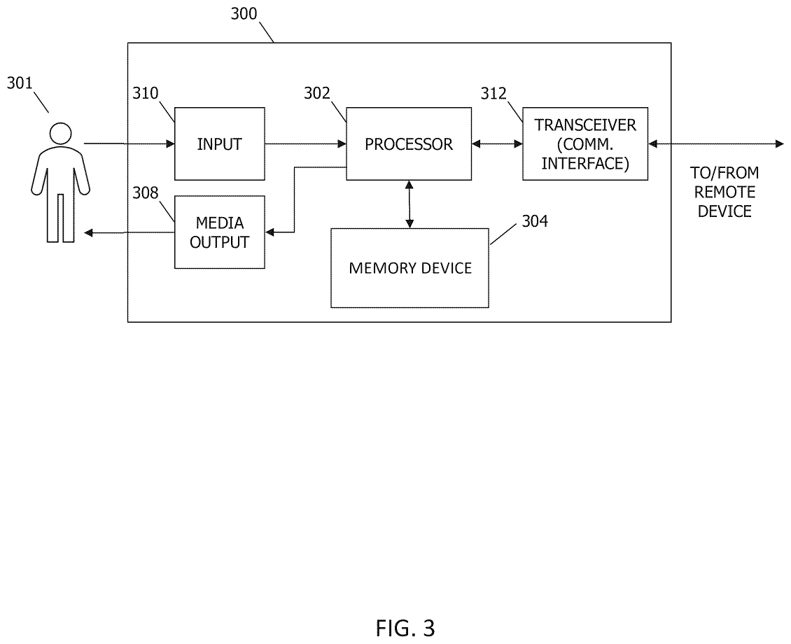

FIG. 3 is an example configuration of a computing system 300 operated by a user 301. In some embodiments, the computing system 300 is the open service computing system 112 (shown in FIG. 1), the payment system 120 (shown in FIG. 1), and/or a computing system of the TPP 108 or issuer 110.

In the example embodiment, the computing system 300 includes one or more processors 302 for executing computer readable instructions. In some embodiments, computer readable instructions are stored in a memory device 304. The processor 302 may include one or more processing units arranged, for example, in a multi-core configuration. The memory device 304 is any device allowing information such as executable instructions, data, and/or written works to be stored and retrieved. The memory device 304 includes one or more computer readable media.

The computing system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the computing system 300 includes an input device 310 for receiving input from the user 301. The input device 310 may include, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 308 and the input device 310. The computing system 300 may also include a transceiver 312 (broadly, a communication interface), which is communicatively connectable to a remote device such as the cardholder computing device 102 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and various software applications. Web browsers enable users to display and interact with media and other information typically embedded on a web page or a website. The various software applications allow the user 301 to interact with the computing system 300 to further communicate with the cardholder computing device 102, the open service computing system 112, etc. to facilitate providing various financial services to the cardholder 104 and, optionally, execute a transaction upon delivery of such services.

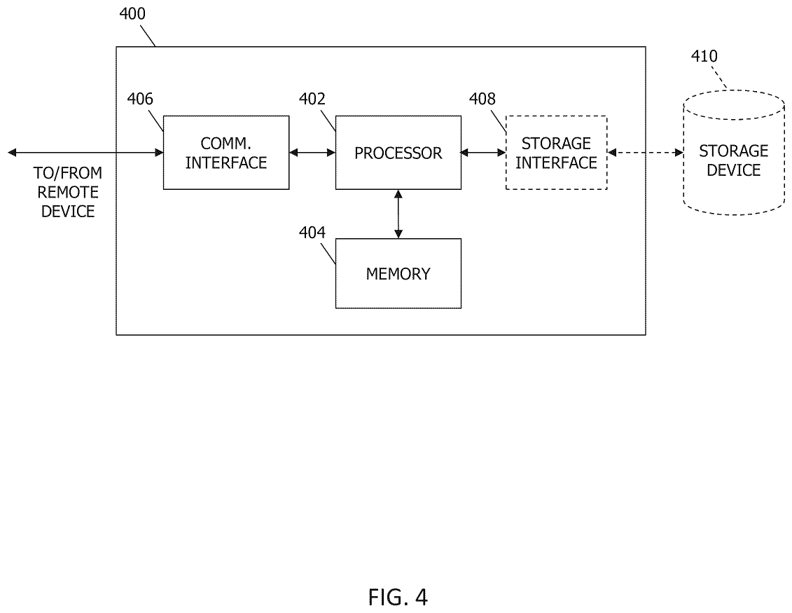

FIG. 4 is an example configuration of a server system 400, such as the database server 122 (shown in FIG. 1). In the example embodiment, the server system 400 includes a processor 402 for executing computer readable instructions. The computer readable instructions may be stored in a memory area 404, for example. The processor 402 includes one or more processing units (e.g., in a multi-core configuration) for executing the computer readable instructions. The computer readable instructions may be executed within a variety of different operating systems on the server system 400, such as UNIX, LINUX, Microsoft Windows®, etc. More specifically, the computer readable instructions may cause various data manipulations on data stored in a storage device 410 (e.g., create, read, update, and delete procedures). It should also be appreciated that upon initiation of a computer-based method, various computer readable instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as cardholder computing device 102, a computing system 300, or another server system. For example, the communication interface 406 may receive communications from the open service computing system 112.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like the databases 124, 138, and 140 (shown in FIG. 1). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the server system 400 is implemented as a software application. In such embodiments, the hardware described above, such as the processor 402, the memory area 404, the communication interface 406, and/or the storage interface 408 may be shared with the hardware components of a computing system 300, such as the processor 302, the memory device 304, and/or the transceiver 312.

### Exemplary Computer-Implemented Methods

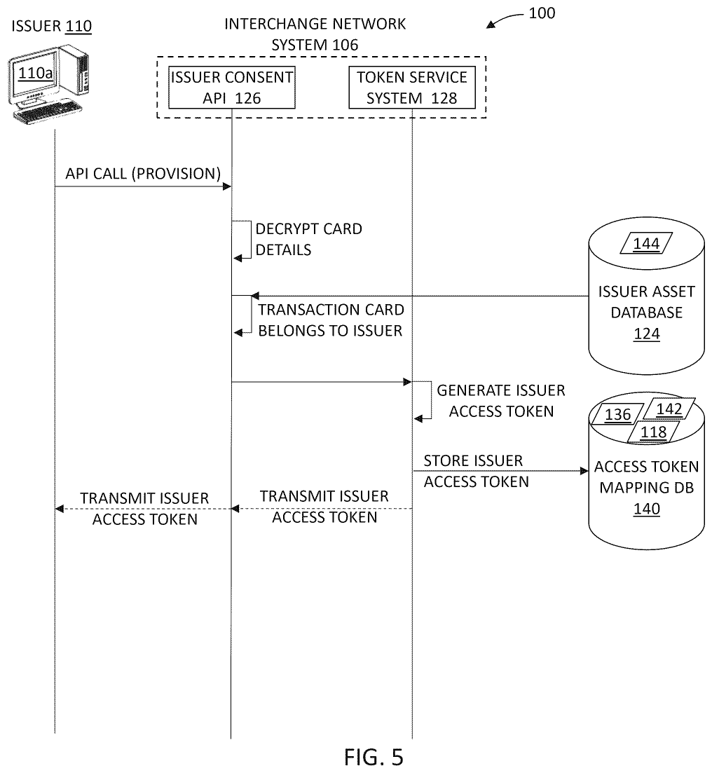

FIG. 5 is a flowchart illustrating various example actions performed by components of the network system 100 to enable an issuer, such as the issuer 110, to request the provisioning of an access ID (or card reference), such as an issuer access token 142, for one of the issuer's corresponding transaction card accounts. The issuer access token 142 allows the issuer to retrieve cardholder consents associated with the corresponding transaction card account, revoke any associated digital access tokens 118 provisioned for TPPs 108, and/or place a “watch” on the corresponding transaction card account. The “watch” provides for the issuer 110 to be notified of subsequent cardholder consent for generation of a digital access token 118. In certain embodiments, the issuer 110 may request bulk provisioning of its transaction card accounts and/or bulk revocation of digital access tokens 118 corresponding to its corresponding transaction card accounts.

In the exemplary embodiment, the issuer 110 may initiate an API method to request one or more issuer access tokens (e.g., the issuer access tokens 142) for its customer transaction card accounts. Because the issuer 110 owns the transaction card accounts, the issuer does not need to request authentication from a cardholder, such as the cardholder 104, before accessing the transaction card account data. However, in certain embodiments, the issuer 110 may authenticate a cardholder, such as the cardholder 104, if the cardholder requests that the issuer 110 revoke a selected digital access token 118 on his or her behalf.

In the exemplary embodiment, using the API approach, the issuer 110 (via the issuer computing device 110a) initiates a provisioning request API call to the issuer consent management API 126 to provision an issuer access token, such as the issuer access token 142, for a corresponding transaction card account. The provisioning request API call includes transaction card account details for one or more of the issuer's associated transaction card accounts. More particularly, the issuer 110 may encrypt transaction card account details (e.g., for one or more transaction card accounts) and include them in the API call to the issuer consent management API 126. The transaction card account details may include one or more of a primary account number (PAN), an expiry date, and/or a card verification code (CVC). The API call may also include a client identifier (e.g., a client ID) that is used to identify the issuer 110.

The client ID may be used to verify that the transaction card accounts associated with the transaction card account details included in the API call belong to the issuer 110. For example, a database, such as the issuer asset database 124, may include a BIN mapping table 144 that includes data that maps a Bank Identification Number (BIN) range to the client ID. A BIN may be assigned by a payment network to an issuer of a payment account, such as the issuer 110. BINs may be consistent with industry account and issuer identification specifications (e.g., International Organization for Standardization (ISO) 7812) such that the payment network, such as the interchange network system 106 (shown in FIG. 1), assigning the BIN may be identified based on the BIN and associated account ranges.

The issuer consent management API 126 decrypts the encrypted transaction card details and checks that each of the transaction card accounts included in the API call belongs to the requesting issuer 110. In particular, the issuer consent management API 126 checks the BIN mapping table 144 stored in the issuer asset database 124 to verify that the requesting client ID maps to the transaction card accounts included in the API call. In response to the transaction card accounts being matched with the client ID, the issuer consent management API 126 transmits the transaction card details to the token service system 128 for generation of the issuer access token(s) 142.

For each of the transaction card accounts associated with the request, the token service system 128 generates an access ID (or card reference), such as the issuer access token 142. Each issuer access token 142 is stored in a database, such as the access token mapping database 140. In one embodiment, the issuer access token 142 is stored in the data mapping table 136. The mapping table 136 includes data that maps the issuer access token 142 and any digital access tokens 118 to the cardholder transaction card account. As such, the issuer access token 142 is mapped to associated digital access tokens 118 via the transaction card account for recall when used in subsequent API calls by the issuer 110.

After the issuer access token (or tokens) 142 is (are) generated, the issuer consent management API 126 transmits the issuer access token(s) 142 to the issuer 110 (e.g., via the issuer computing device 110a). For example, the issuer consent management API 126 may communicate with the issuer computing device 110a to transmit the issuer access token(s) 142 thereto. The issuer 110 stores the issuer access token(s) 142 for subsequent use in API calls to the issuer consent management API 126, for example, for retrieval of cardholder consent data and digital access token(s) 118 corresponding to the transaction card account(s).

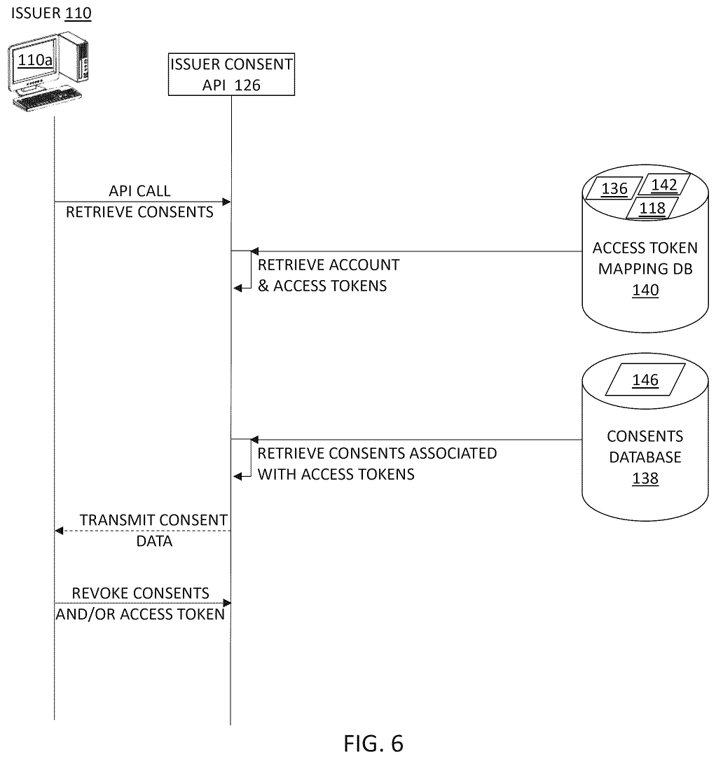

FIG. 6 is a flowchart illustrating various example actions performed by components of the network system 100 to enable an issuer, such as the issuer 110, to retrieve financial data access consent and/or permission granted by the cardholder 104 to a third party, such as the TPP 108. In the exemplary embodiment, the issuer 110 may initiate an API method to retrieve cardholder consents to TPPs 108 using the issuer access token 142 for a corresponding customer transaction card account. In particular, the issuer 110 (via the issuer computing device 110a) initiates a consents retrieval API call to the issuer consent management API 126 to retrieve any TPPs 108 that have digital access tokens 118 associated with the cardholder account in question and the consents granted by the cardholder 104 under the particular digital access tokens 118.

The issuer consent management API 126 checks the data mapping table 136 stored on the access token mapping database 140 to identify any access tokens 118 mapped to the issuer access token 142, for example, via a corresponding cardholder transaction card account. Upon identifying one or more corresponding digital access tokens 118, the issuer consent management API 126 checks a data mapping table 146 stored on the consents database 138 to retrieve the corresponding TPP ID data. The data mapping table 146 includes one or more table rows mapping a respective cardholder transaction card account to one or more digital access tokens 118. In addition, the table includes consent data associated with each of the mapped digital access tokens 118. For example, and without limitation, the consent data may include consent parameters granted to the corresponding TPP 108, the terms and conditions the cardholder has agreed to with the TPP 108, date and time of the consent and/or generation of the digital access token 118, expiry date and time of the digital access token 118, and the like. The issuer consent management API 126 retrieves the consent data corresponding to the cardholder transaction card account associated with the issuer access token 142 and transmits it to the issuer 110, and more particularly, to the issuer computing device 110a via the network 114 (shown in FIG. 1).

In certain embodiments, the issuer 110 can revoke one or more consent parameters and/or the digital access token(s) 118. For example, a cardholder may request that the issuer revoke the digital access token 118 given to a TPP 108. Further, an issuer may determine that a TPP 108 is disfavored and should not have access to one or more of its customer transaction card accounts. In such instances, the issuer 110 may revoke the digital access token(s) 118 by transmitting a token revocation request message, including the issuer access token(s) 142, to the issuer consent management API 126 to request that the associated digital access token(s) 118 be suspended and/or deleted such that the digital access token(s) 118 can no longer be used to retrieve cardholder financial account data. Upon receipt of the token revocation request message, the issuer consent management API 126 instructs the token service system 128 to revoke or delete the digital access token 118.

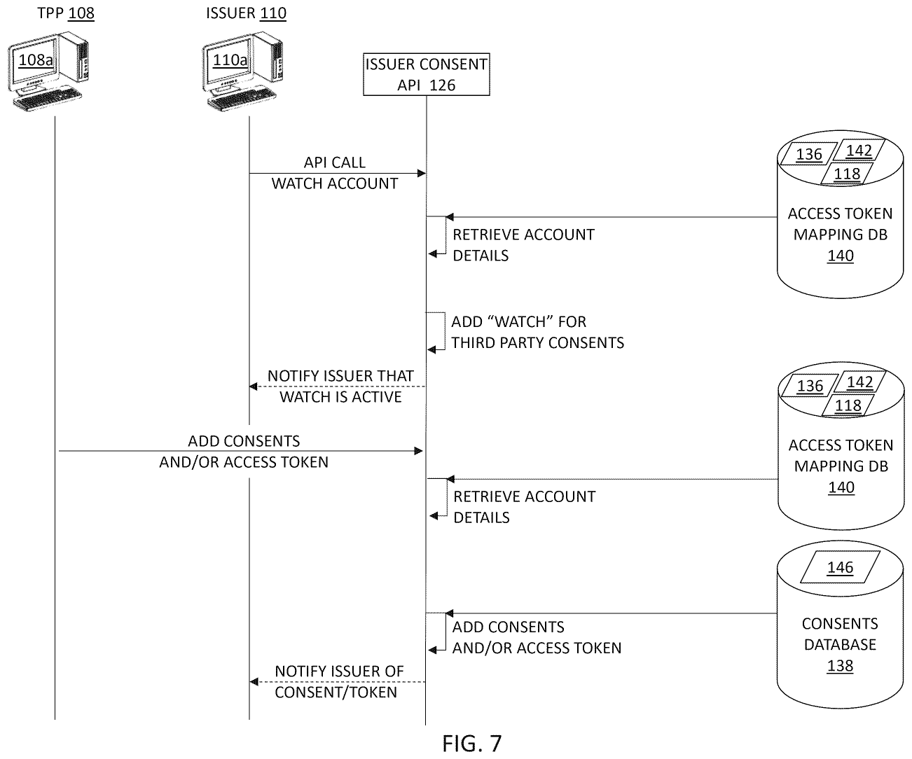

FIG. 7 is a flowchart illustrating various example actions performed by components of the network system 100 to enable an issuer, such as the issuer 110, to add a “watch” to one or more of its customer transaction card accounts. The “watch” provides for the issuer 110 to be notified of subsequent cardholder consent for generation of a digital access token 118. In the exemplary embodiment, the issuer 110 may initiate an API method to request that a “watch” be added to an account associated with the issuer access token 142. Using the API approach, the issuer 110 (via the issuer computing device 110a) initiates a “watch account” API call to the issuer consent management API 126 using the issuer access token 142.

The issuer consent management API 126 checks the data mapping table 136 stored on the access token mapping database 140 to identify the transaction card account details for the corresponding transaction card account. The issuer consent management API 126 then adds a “watch” to the associated transaction card account. For example, in one embodiment, the issuer consent management API 126 may set a watch flag in the data mapping table 136 that indicates that notice of any digital access token activity associated with the flagged account is to be transmitted to the issuer 110. After the “watch” is added to the account, the issuer consent management API 126 transmits a message to the issuer indicating that the watch is active (i.e., the watch flag has been set).

When a TPP 108 attempts to add cardholder consent data and/or submits a digital access token generation request message requesting that a digital access token 118 be generated for the flagged account, the issuer consent management API 126 generates the digital access token 118 and adds it to the access token mapping database 140 and any related consent data to the consents database 138. The issuer consent management API 126 reads the watch flag corresponding to the transaction card account and notifies the issuer 110 that new consent data and/or digital access token 118 has been entered into the databases. In certain embodiments, it is noted that the issuer consent management API 126 may notify the issuer 110 before generating the access token 118 and adding the consents data to the databases. In such instances, the issuer consent management API 126 may be configured to receive an authorization response from the issuer 110 before proceeding. If the issuer 110 provides a declination response, the issuer consent management API 126 may decline to generate an access token 118 for the requesting TPP 108.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A computing system comprising:
an issuer assets database storing a Bank Identification Number (BIN) mapping table;
a token mapping database storing a data mapping table that includes token-to-card mapping data;
a consents database storing cardholder consent data;
a communication interface;
one or more processors coupled to the issuer assets database, the token mapping database, the consents database, and the communication interface; and
a memory comprising computer-executable instructions therein, which when executed by the one or more processors, cause the one or more processors to perform operations comprising:
receiving, via the communication interface, a request message from an issuer computing device requesting provisioning of an issuer access token, the request message including a client identifier (ID) and encrypted transaction card details for a transaction card account associated with an issuer;
decrypting the encrypted transaction card details;
matching the client ID to the transaction card details using the BIN mapping table;
in response to a successful match, generating the issuer access token associated with the transaction card account and a corresponding digital access token;
storing the issuer access token and the digital access token in the token mapping database;
receiving, via the communication interface, a token revocation request message from the issuer computing device, the token revocation request message including the issuer access token;
in response to the token revocation request message, disabling access to financial account data associated with the transaction card account, comprising one of the following:
suspending the digital access token by updating a token status in the data mapping table; and
deleting the digital access token from the data mapping table.

2. The computing system in accordance with claim 1,
said operation of storing the issuer access token comprises storing the issuer access token in the data mapping table, wherein the token-to-card mapping data includes data mapping the issuer access token to the transaction card account.

3. The computing system in accordance with claim 2, wherein the data mapping table further includes data that maps the transaction card account to the digital access token, the digital access token associated with the cardholder consent data stored in the consents database.

4. The computing system in accordance with claim 3,
the computer-executable instructions further causing the one or more processors to perform an operation comprising transmitting, via the communication interface, the issuer access token to the issuer computing device.

5. The computing system in accordance with claim 4,
the computer-executable instructions further causing the one or more processors to perform an operation comprising receiving, via the communication interface, a consents retrieval message from the issuer computing device, the consents retrieval message including the issuer access token.

6. The computing system in accordance with claim 5,
the computer-executable instructions further causing the one or more processors to perform operations comprising:
checking the data mapping table using the issuer access token received with the consents retrieval message; and
identifying the digital access token mapped to the issuer access token via the transaction card account.

7. The computing system in accordance with claim 6,
the computer-executable instructions further causing the one or more processors to perform an operation comprising retrieving third party provider (TPP) ID data associated with the digital access token and the cardholder consent data associated with the digital access token.

8. The computing system in accordance with claim 7, wherein the cardholder consent data includes one or more of the following: consent parameters granted to the TPP; terms and conditions agreed to with the TPP; date and time of creation of the digital access token; and expiry date and time of the digital access token.

9. The computing system in accordance with claim 7,
the computer-executable instructions further causing the one or more processors to perform an operation comprising transmitting the TPP ID data and the cardholder consent data to the issuer computing device.

10. The computing system in accordance with claim 1,
the computer-executable instructions further causing the one or more processors to perform an operation comprising transmitting, via the communication interface, the issuer access token to the issuer computing device.

11. The computing system in accordance with claim 1,
the computer-executable instructions further causing the one or more processors to perform an operation comprising receiving, via the communication interface, a watch account message from the issuer computing device, the watch account message including the issuer access token.

12. The computing system in accordance with claim 11,
the computer-executable instructions further causing the one or more processors to perform operations comprising:
checking the data mapping table using the issuer access token received with the watch account message to identify the corresponding transaction card account; and
setting a watch flag in the data mapping table corresponding to the transaction card account, the watch flag indicating that the issuer is to be notified of any digital access token activity associated with the transaction card account.

13. The computing system in accordance with claim 12,
the computer-executable instructions further causing the one or more processors to perform an operation comprising transmitting a notification message to the issuer computing device indicating that the flag watch is set in the data mapping table.

14. The computing system in accordance with claim 13,
the computer-executable instructions further causing the one or more processors to perform an operation comprising receiving, via the communication interface, a digital access token generation request message from a third party provider (TPP) computing device.

15. The computing system in accordance with claim 14,
the computer-executable instructions further causing the one or more processors to perform operations comprising:
reading the watch flag corresponding to the transaction card account; and
transmitting a watch notification message to the issuer computing device.

16. The computing system in accordance with claim 15,
the computer-executable instructions further causing the one or more processors to perform an operation comprising transmitting a notification to the issuer computing device before generating a requested access token requested by the TPP computing device.

17. The computing system in accordance with claim 16,
the computer-executable instructions further causing the one or more processors to perform operations comprising:
receiving an authorization response from the issuer computing device, the authorization response declining to authorize the generation of the requested digital access token; and
declining to generate the requested access token for the requesting TPP computing device.

18. The computing system in accordance with claim 15,
the computer-executable instructions further causing the one or more processors to perform operations comprising:
generating the digital access token;
adding the digital access token to the token mapping database; and
adding any related consent data to the consents database.
